(19) United States
(12) Patent Application Publication
(10) Pub. No.: US 2024/0320605 A1
(43) Pub. Date: Sep. 26, 2024

(54) LOAD AWARE STACKING AND PACKAGING OF ITEMS

(71) Applicant: INTERNATIONAL BUSINESS MACHINES CORPORATION, Armonk, NY (US)

(72) Inventors: Katsuyuki Sakuma, Fishkill, NY (US); Sarbajit K. Rakshit, Kolkata (IN)

(21) Appl. No.: 18/186,870

(22) Filed: Mar. 20, 2023

(51) Int. Cl. G06Q 10/0832; G06Q 10/047; G06Q 10/083

(52) U.S. Cl. CPC G06Q 10/0832; G06Q 10/047; G06Q 10/0838

(57) ABSTRACT

Stack load aware stacking and packing of items can include determining, using computer hardware, package attributes for a plurality of packages. The package attributes include weights of the packages and dimensions of the packages. Vehicle attributes for a delivery vehicle used to transport the plurality of packages are determined using the computer hardware. The vehicle attributes include dimensions of a cargo space of the delivery vehicle. A simulation configured to simulate forces acting on individual ones of the plurality of packages as placed in a stack configuration for a route is generated using computer hardware based on the package attributes and the vehicle attributes. The simulation is executed using the computer hardware to determine a load on respective ones of the plurality of packages. Using the computer hardware, a packing type for each package is selected based on the load for the respective packages.

### BACKGROUND

This disclosure relates to computer-based techniques for the automated, load aware stacking and packaging of items for transit and/or delivery.

The popularity of online or web-based shopping has increased dramatically over the last several years. Transporting such a large number of packages from manufacturers to end customers on a daily basis requires that delivery systems operate at high levels of efficiency. At different points of the supply chain, packages may be stacked and/or restacked multiple times for storage in warehouses or for transport in one or more delivery vehicles. The stacking of packages attempts to take advantage of the available storage capacity of the warehouse and the available cargo capacity of the delivery vehicles. While in stacks, whether stationary or in transit, the packages are subjected to different forces. To avoid damage to the packages, proper stacking and/or packaging is a significant concern.

### SUMMARY

In one or more embodiments, a method includes determining, using computer hardware, package attributes for a plurality of packages. The package attributes include weights of the packages and dimensions of the packages. The method includes determining, using the computer hardware, vehicle attributes for a delivery vehicle used to transport the plurality of packages. The vehicle attributes include dimensions of a cargo space of the delivery vehicle. The method includes generating, using the computer hardware, a simulation configured to simulate forces acting on individual ones of the plurality of packages as placed in a stack configuration for a route based on the package attributes and the vehicle attributes. The method includes executing, using the computer hardware, the simulation to determine one or more forces exerted on respective ones of the plurality of packages. The method includes selecting, using the computer hardware, a packing type for each package based on the one or more forces exerted on the respective packages.

The foregoing and other implementations can each optionally include one or more of the following features, alone or in combination. Some example implementations include all the following features in combination.

In some aspects, the packing type includes a particular container for each package having a strength rating selected based on the one or more forces applied to the package.

In some aspects, the packing type includes a particular packing material for each package.

In some aspects, at least one of a height, a width, or a depth of the stack configuration is determined based on the dimensions of the cargo space of the vehicle.

In some aspects, the vehicle attributes include a condition of the delivery vehicle.

In some aspects, the condition of the delivery vehicle includes condition of a suspension of the delivery vehicle.

In some aspects, the simulation further determines the one or more forces exerted on the respective ones of the plurality of packages for the route based on route attributes.

In some aspects, the route attributes include condition of the route.

In some aspects, the simulation further determines the one or more forces exerted on the respective ones of the plurality of packages based on historical shipping data.

In one or more embodiments, a system includes one or more processors configured to initiate and/or perform executable operations as described within this disclosure.

In one or more embodiments, a computer program product includes a computer readable storage medium having program instructions stored thereon. The program instructions are executable by one or more processors to cause the one or more processors to execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a system for performing automated, load aware stacking and packaging of items.

FIG. 2 illustrates an example architecture for a Stack-Aware Packaging (SAP) engine that may be executed by the data processing system of FIG. 1.

FIG. 3 is an example method of operation of the SAP engine of FIGS. 1 and 2.

FIG. 4 illustrates an example implementation of a computing environment capable of executing the SAP engine described herein.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to computer-based techniques for the automated, load aware stacking and packaging of items for transit and/or delivery. In accordance with the inventive arrangements disclosed herein, methods, systems, and computer program products are provided that facilitate efficient packaging of items for shipment. In one or more embodiments, a system is provided that is capable of determining a type of packaging to be used for a given package of items. The type of packaging can include a type of container to be used for the package. The type of packaging also can include particular packing materials, if any, included in the container with the items of the package to ensure safe delivery of the items as packaged undamaged to a given destination.

Delivery vehicles carry items from one location to another. In many cases, the items are grouped into packages and stacked in the delivery vehicle. Proper packaging for the items being shipped is required to protect the products of the packages. For example, items grouped into a package may be placed in a container, referred to herein as being containerized. An example of a container is a carton, a cardboard box, a bag, a padded envelope, or the like. The containers may be stacked. Each package, as containerized, has its own weight. Those packages positioned lowest in a stack of packages bear the greatest weight (e.g., static load) due to the other containers being stacked vertically on top. That is, containers located lower in a stack must be of sufficient strength to bear the weight of all containers stacked above. In transit, while transported on the delivery vehicle, there may be sudden movements, e.g., jerking of the delivery vehicle, that subjects the containers being shipped to dynamic loads.

Each of the containers used to ship a package may be rated with a particular strength. That is, each container may be rated to hold contents of a particular weight and/or to bear a certain amount of weight. The containers may be rated for certain static and/or dynamic loads. Exceeding the capabilities of the container, e.g., subjecting the container to more static and/or dynamic force than the container is rated to bear, may deform, rupture, or otherwise damage the container and the items contained therein. Those containers located toward the bottom of a stack bear more weight than the containers located toward the top of the stack. Thus, the packages located toward the bottom of the stack must have increased strength relative to containers located toward the top of the stack.

In one or more example implementations, the system is capable of determining the type of packaging to be used for a package based on a variety of different attributes. These attributes may include, but are not limited to, package attributes such as the items included in the package and/or weight of the package, the location of the package within a stack of packages, vehicle attributes describing the delivery vehicle that is to deliver the package, route attributes describing the particular route the delivery vehicle is to traverse in delivering the package, historical shipping data which may include sensor data obtained from actual delivery vehicles and/or containers while in transit, and the like.

For example, the system is capable of analyzing a number of packages to be delivered by a delivery vehicle, analyzing the dimension of the cargo space of the delivery vehicles, analyze the condition of the delivery vehicles (e.g., the condition of the suspension), analyze the weight of the individual items being shipped and as grouped into packages, and/or analyze the attributes of the route such as the road conditions. These parameters may be incorporated into a simulation of the forces to which the packages, as may be included in a stack configuration, are subjected while in route. The results of the simulation, e.g., whether a given package, as containerized, makes it to the destination without damage may be used by the system to select the packaging type for the package. Selecting the appropriate packaging type that survives the simulation ensures that items arrive at their destination undamaged, may reduce shipping costs, and reduces waste by, at least in part, reducing the amount of material needed to ship packages and/or ensuring that additional material/stronger containers are used only where needed.

In another aspect, the inventive arrangements may incorporate historical data and/or historical learning. The system, for example, is capable of analyzing package handling along a route. As used within this disclosure, the term “route” means the handling of a package from a starting point to a destination. The starting point of the route may be a manufacturer or supply house. The destination of the route may be a location of a customer. In this regard, a route may refer to one or more transports of packages in one or more delivery vehicles (e.g., one or more segments of the route) and/or intermediate storage of packages, e.g., in a warehouse between segments. The historical data may detect points along a route where the forces exerted on a given container may damage the container.

In one or more examples, the system may implement machine learning to detect differences in container designs, cost of the different container designs, and the performance of the respective container designs under different loads (e.g., which container designs are and are not damaged under different loads).

In one or more other embodiments, the system is capable of analyzing the properties of the packages to determine how the packages, as containerized, are stacked whether on a delivery vehicle or are stacked on a rack or a shelf whether within a delivery vehicle or in a warehouse. For example, based on an identified packaging health of individual products or a cluster of products, dimension of packages, and the like, the system is capable of determining how the stacking of a container is to be performed. In this example, the phrase “packaging health” refers to whether a package is damaged. The system may, for example, control the operation of a robotic packaging handling system (e.g., a robotic arm) to stack packages in a particular order placing certain packages at lower layers and other packages at upper layers.

In another aspect, the system is capable of determining a structure of a stack of packages (e.g., a stack configuration), the load on the different packages as arranged according to the stack configuration, and determining any likely load on the packages of the stack configuration given the various attributes described herein such as, for example, vehicle condition, route condition, expected vehicle movement, etc. In some examples, the system may control certain aspects or driving parameters of the delivery vehicle to minimize the dynamic load placed on the packages while in transit.

In one or more embodiments, the system is capable of generating one or more simulations of packages throughout one or more stages of a route. The simulations, as executed, are capable of determining forces that act on the respective packages throughout the one or more stages the route. These stages may include various locations throughout the supply chain, locations of the package as may be stored and/or stacked in different locations and/or vehicles throughout the supply chain, etc., including while in transit to a destination such as an endpoint (e.g., an end customer). The simulations, as executed, are capable of determining a load, e.g., forces, exerted on the packages. The loads may be static and/or dynamic. Based on the determined load, the system is capable of selecting a packing type for the package. The packing type may specify a particular container and/or packing materials to be included in the container to support and/or buffer any items within the container.

For example, based on a simulation of package stacking to determine stack load on the packages, the system is capable of designing a stack configuration having different packages located at different levels of the stack. The system is capable of reducing the aggregated packaging cost and ensuring that packages are delivered undamaged (e.g., safely). The type of packaging selected ensures that the package, as placed in the selected type of container, will withstand the forces to which the container may be subjected throughout the route. The container, for example, may be selected to withstand forces exerted on the container as that container exists within various stacks of containers in transit.

For example, based on the forces estimated to be exerted on the package from simulation, a container having a strength capable of withstanding the estimated forces may be selected. This ensures that those packages that may require stronger containers are assigned such containers. Those packages that do not require stronger containers may be assigned other more appropriate containers (e.g., containers of less strength and cost). By selecting appropriate packing type for a given package, significant cost and packing resources may be conserved. Moreover, the items may be delivered to destinations with far less likelihood of being damaged.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

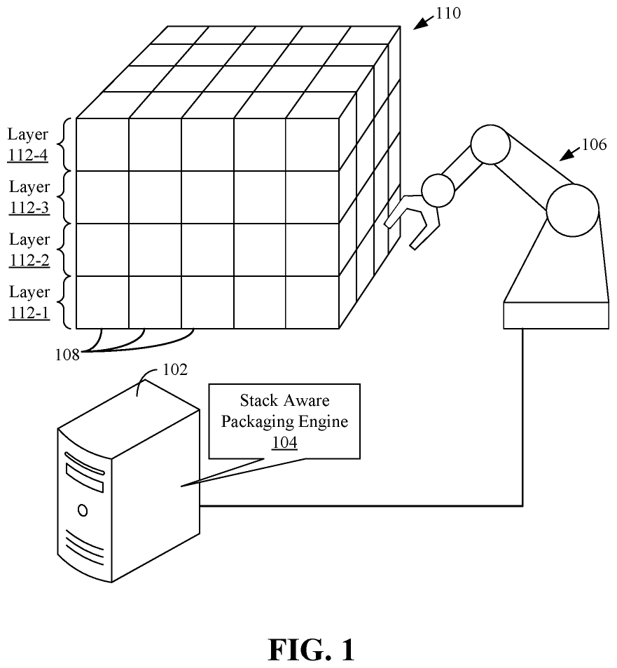

FIG. 1 illustrates an example of a system that is capable of performing automated, load aware stacking and/or packaging of items. The items may be packaged and stacked in a load aware manner for transit and/or delivery. In the example, a data processing system 102 is shown that executes a stack aware packaging (SAP) engine 104. SAP engine 104, executing in data processing system 102, is coupled to a robotic arm 106. Robotic arm 106 is capable of stacking containers 108 to form a stack 110 under control of data processing system 102. In the example, stack 110 includes a plurality of layers 112-1, 112-2, 112-3, and 112-4. It should be appreciated that the dimensions of stack 110 in terms of width, depth, and/or height (e.g., number of layers 112) may vary depending on a number of different attributes as described hereinbelow in greater detail.

In the example, data processing system 102 may execute operational software such as an operating system and SAP engine 104. SAP engine 104 is capable of determining packaging type for items grouped into packages. As discussed, packaging type may include, but is not limited to, a particular container (e.g., type or model) and/or a type of packing material, if any, that may be included in the selected container with the items of the package. Within this disclosure, the term “package” means a grouping of one or more items of an order that are placed into a single and same container for shipping. Thus, an order may include one or more items (e.g., products). Each order may be fulfilled by grouping the items into one or more packages. Each container includes only items of a same package. Thus, in reference to FIG. 1, each container 108 includes a package. A package within a container 108 is said to be containerized.

Data processing system 102 may communicate with robotic arm 106 via any of a variety of communication techniques, whether wired or wireless connections. Examples of wireless connections may include WiFi (e.g., any one of the IEEE 802.11 family of standards), Bluetooth®, or the like. In one aspect, having selected packaging types for packages to be included in stack 110, SAP engine 104 is capable of providing stacking instructions to robotic arm 106 so that robotic arm 106 may arrange (e.g., stack) a plurality of packages that have been included in containers and allocated to the stack 110 to physically create or form stack 110.

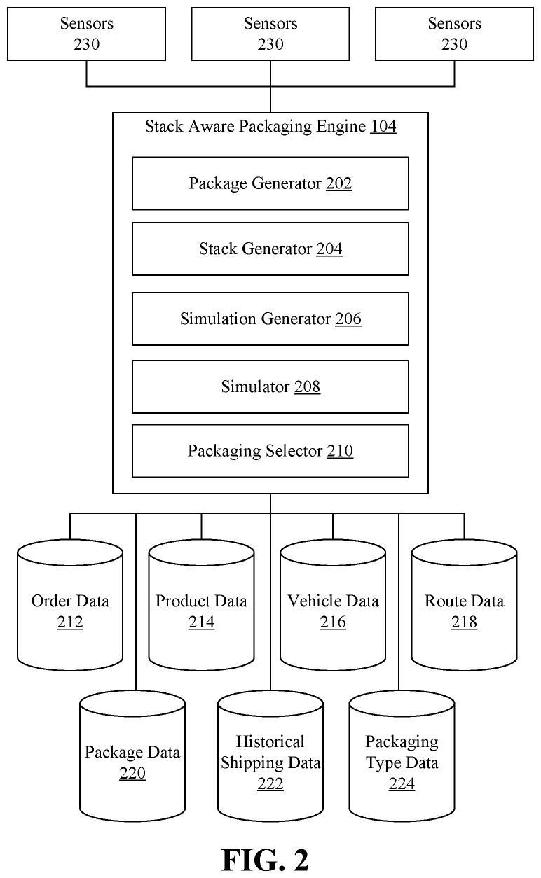

FIG. 2 illustrates an example architecture for SAP engine 104 that may be executed by data processing system 102. In the example, SAP engine 104 includes a package generator 202, a stack generator 204, a simulation generator 206, a simulator 208, and a packaging selector 210.

In the example, SAP engine 104 further is coupled with a variety of data sources. In one aspect, the data sources may be data repositories implemented as databases stored in physical data storage devices. It should be appreciated, however, that the data illustrated may be stored using flat files, markup language files, or other data storage techniques besides those noted. In the example, SAP engine 104 is coupled to order data 212, product (e.g., item) data 214, vehicle data 216, route data 218, package data 220, historical shipping data 222, and packaging type data 224. The data sources may be stored in a single storage device, a plurality of storage devices, or in respective storage devices. In any case, the storage devices are coupled to SAP engine 104. In one or more embodiments data sources 212-224 are stored within data processing system 102. In one or more other embodiments, data sources 212-224 are implemented as separate or remote data storage systems coupled to data processing system 102.

In the example of FIG. 2, a plurality of orders may be received by an order intake system (not shown). The order intake system is capable of receiving orders from one or more different sources. The order intake system may store the received orders in order data 212. Each order specifies one or more items. For example, the order intake system may receive orders from Web-based sources (e.g., online or Web-based stores) or other order entry systems.

Product data 214 stores data about the individual products that may be grouped into packages and delivered to destinations. Product data 214 may include, on a per item and/or product basis, a type or classification of the item (e.g., food, cleaning supply, type of food item (e.g., fresh, frozen, canned, etc.), office supply, etc.), dimensions of the item, and weight of the item.

Vehicle data 216 stores attributes for different delivery vehicles used to transport the items and/or packages. The vehicle attributes can include, but are not limited to, dimensions of the cargo space of the delivery vehicle, a condition of the delivery vehicle, a type of suspension of the delivery vehicle, a condition of the suspension of the delivery vehicle, a type of delivery vehicle (e.g., cargo truck, tractor trailer, van, plane, train, boat/ship, etc.). In one aspect, the condition of the delivery vehicle and/or suspension may be specified as an age that may be used as an indicator of the intensity of dynamic forces that will be exerted on the packages transported by the delivery vehicle.

As an illustrative and non-limiting example, the condition of the suspension of the delivery vehicle may be used as a factor to scale an ideal condition of the suspension of the delivery vehicle to provide an indication of the intensity of dynamic forces (e.g., jerking and/or other movement) applied to packages carried by the delivery vehicle. The dynamic forces applied to the packages, for example, may be scaled with the type of suspension and/or condition of the suspension (e.g., where suspension rated in better condition may reduce the dynamic forces applied to the packages carried by the delivery vehicle). The vehicle data 216 may be specified on a per-vehicle basis.

Route data 218 may specify the particular routes that delivery vehicles travel in delivering items to destinations. The routes may specify the types of roads traversed (e.g., highway, presence of stop signs and/or traffic lights, residential roads), speed limits of the roads, condition of the roads (e.g., bumpy, smooth, new, old), and the like. The route data 218 may specify, for each route, additional information such as the type of terrain (e.g., flat, hilly, mountainous, dirt, paved, winding/curvy, gravel, etc.). The route data 218 may be specified on a per-route basis. The route date 218 in combination with the vehicle data 216 may be used, in combination, to determine forces that are applied to packages in route. The forces applied to a package may be increased due to a bumpy road that is exacerbated by a delivery vehicle with suspension in poor condition. Similarly, forces exerted on a package may be lessened despite a route with a bumpy road where a vehicle has suspension in excellent condition.

Package data 220 may specify which item or items are organized into a package. The package data 220 may store a list of package(s) for each order. That is, the items of each order may be grouped into one or more packages (groupings of items) to be delivered to the destination. Each package is placed into its own individual container for delivery. Thus, the package data may indicate which items are in a given package, the order to which the package corresponds, a total volume of the package as a sum of the volumes of the individual items in the package, and a total weight for the package in terms of a sum of the weights of the individual items in the package. The package data 220 may be specified on a per-package basis.

Historical shipping data 222 may include information about prior package deliveries. For example, for prior package deliveries, the historical shipping data 222 may store vehicle data for the package delivery, route data for the package delivery, and various types of sensor data. The sensor data may be collected by one or more sensors 230 that may be disposed in the cargo area of the delivery vehicles. In one or more example implementations, the sensors 230 may be Internet-of-Thing (IoT) sensors. The sensors 230 may measure dynamic forces within the cargo area of the delivery vehicles. For example, sensors 230 may include accelerometers capable of measuring vehicle movement including sudden movements (e.g., jerking) including acceleration and/or deceleration in any direction (e.g., forward-to-back, side-to-side, and/or vertical movement (bumps)). The sensors 230 are capable of determining an indication of how the cargo area of the delivery vehicle vibrates while traversing the route.

Sensors 230 may include camera-based image capture systems (e.g., image and/or video) capable of capturing images of the cargo area of the vehicle, the route or roadway (e.g., external facing cameras); Global Positioning System (GPS) devices, transponders, or the like for determining the location of the delivery vehicle; and/or code scanning systems to detect unique identifiers on packages such as bar codes, QR codes, or other visually identifying information that may be detected by way of image processing.

The historical shipping data 222 may specify additional information such as the placement of packages, as containerized, within stacks as transported in delivery vehicles and/or as placed or stored temporarily in holding facilities (e.g., warehouses). For example, the location may include an (x, y, z) coordinate of the package within a stack, where the z component may be specified as a layer of the stack. The historical shipping data 222 may also specify the stack configuration containing the package(s) so that the weight stacked above each respective package in the stack may be ascertained.

Packaging type data 224 may include one or more different types of data. For example, the packaging type data 224 may specify available container types (e.g., specific container models) for transporting packages. For each different container type, packaging type data 224 may specify a container specification that includes a maximum weight that the container is rated to carry, the type of container (e.g., material that the container is made of), cost of the container, strength or load bearing capacity of the container (e.g., how much weight can be stacked atop of the container), and the like. In some cases, containers may be of the same or similar size for stacking but have different parameters such as different weight carrying capacities, different load bearing capacities, be made of different materials or same/similar materials of different thicknesses and/or strengths, and/or have different costs. In other cases, containers may be of differing sizes and also have different parameters such as different weight carrying capacities, different load bearing capacities, and/or be made of different materials or same/similar materials of different thicknesses and/or strengths, and/or have different costs.

Packaging type data 224 may also specify available types of packing materials. The available types of packing materials may include air-filled bags, foam, packing peanuts, or other materials that may be included inside the container to prevent items of the package from moving about and/or being damaged in transit. In some cases, the type of packing materials used within a container may contribute to the load bearing capacity of the container by preventing the container from being deformed or damage under different loads.

Referring to SAP engine 104, package generator 202 is capable of determining, based on the particular items of each order, a number of packages that will be required to fulfill the order. Package generator 202 may assign items of orders to packages and output packages (e.g., groups of items) for each of a plurality of orders. For example, package generator 202 is capable of analyzing orders from order data 212 to determine which items are specified by each order and retrieving product information for the items from product data 214. For a given order (e.g., each order), package generator 202 is capable of determining the number of items on the order, a weight of each item of the order, the size (e.g., dimensions) of each item of the order, the shape of each item of the order, a type or classification of each item of the order, and/or which customer placed the order.

In one aspect, package generator 202 may include logic for processing the product information. The logic is capable of comparing the order information described above against various rules for generating packages for the order. For example, the logic may specify compatibility among items based on product type or classification so that package generator 202 may determine which products or types of products may be packaged together (e.g., placed in a same container) and which may not. For purposes of illustration, package generator 202 may place cleaning products of an order in a separate package than food products of the same order. In some aspects, the logic may create packages having weights and/or volumes that do not exceed the maximum volume and/or weight capacity of certain containers as may be specified by packaging type data 224. Package generator 202 is capable of determining how many packages are required to fulfill an order based the aforementioned data relating to the items of the order and the capabilities of the container(s) available.

Though package generator 202 may be implemented as described herein, in one or more other embodiments, package generator 202 may implemented using available package generation technologies or techniques and/or augmented with the additional logic described herein.

Stack generator 204 is capable of generating stack configurations for packages as determined by package generator 202. In one or more examples, stack generator 204 is capable obtaining an estimate of the weight and size of each package (e.g., group of items) as determined by package generator 202 and stored in package data 220. Stack generator 204 is capable of generating stack configurations by assigning each package of a stack (e.g., stack 110) to a respective location in the stack configuration. A stack configuration is a virtual model of a physical stack of packages in which the individual packages are assigned particular locations for the stack represented by the model. That is, stack generator 204 is capable of assigning each package an (x, y, z) coordinate for a given stack configuration where the x and y coordinates dictate the position/location of a package in a given layer and the z coordinate indicates the particular layer to which the package is assigned in the stack configuration.

In one aspect, the packages may be assigned to layers based on weight and/or size. For example, heavier packages may be placed toward the bottom of stack 110 while lighter packages are placed toward the top. This approach, where increasingly heavier packages are assigned to lower layers of stack 110 (e.g., to layer 112-1 and/or 112-2), ensures that the resulting stack 110 will be steady and secure during transit. This approach also reduces the weight born by packages placed at lower-level layers as the lighter packages are placed in the upper layers of the stack. Though stack generator 204 may be implemented as described herein, in one or more other embodiments, stack generator 204 may implemented using available stack generation technologies or techniques and/or augmented with the additional logic described herein.

Simulation generator 206 is capable of generating one or more simulations for each package as that package is to be delivered to an endpoint. For example, the simulation generator 206 may generate one or more simulations that take into account the various attributes described herein with respect to order data 212, product data 214, vehicle data 216, route data 218, package data 220, historical shipping data 222, and packaging type data 224 for one or more packages along a given route. As an example, simulation generator 206 is capable of generating one or more simulations that determine forces applied to the packages throughout different stages of a route from the starting point to the destination (e.g., a customer). The different stages may include storage in intermediate locations (warehouses), transport in one or more delivery vehicles along the route, etc.

For purposes of illustration, a simulation may account for location of the package within a stack (e.g., an x, y, z coordinate), the size of the stack as may be determined in view of the size of the cargo area of the delivery vehicle that is used on the route that covers the endpoint for the package (e.g., length, width, and height in layers or absolute terms), the condition of the delivery vehicle including suspension, attributes of the route itself, historical delivery of packages similarly placed or of similar contents to similar destinations by way of similar routes and/or delivery vehicles. The historical shipping data 222 may indicate, for example, whether particular packages with specified packaging types (e.g., a particular container and particular packing material) were damaged upon arrival at the destination.

In one or more embodiments, simulation generator 206 is capable of determining the dimensions and center of gravity of each package. Simulation generator 206 may determine product weights and an aggregated weight for each package. Based on the stack configuration determined by stack generator 204, simulation generator 206 is capable of generating a simulation of loads applied to the respective packages of the stack configuration throughout the route. The loads account for the position of each package in the stack configuration (e.g., the weight of packages stacked above each respective package in the stack configuration given the known locations of packages in the stack configuration). For example, for a package in layer 112-1, the simulation subjects that package to the aggregated weight (the package weight) of each package located vertically above (e.g., having a same x-y coordinate) in layer 112-2, layer 112-3, and layer 112-4 for the route. The simulations generated may be used to determine the minimum strength of a container required for each package to avoid that container (or package) from being damaged given the location of each package in a stack configuration. Different simulations may be generated for different stack configurations for a given set of packages.

Simulator 208 is capable of executing the one or more simulations generated by simulation generator 206. Simulator 208, upon executing a simulation, is capable of determining the forces, e.g., the static and/or dynamic forces, exerted on the packages throughout the route, whether in warehouses and/or in delivery vehicles.

In one or more embodiments, the simulations may be implemented using digital twin technology. A digital twin is a virtual model designed to accurately reflect a physical object such as a package or a containerized package. The object being studied may be outfitted with various sensors related to areas of functionality. These sensors produce data about different aspects of the physical object's performance, such as deformation, temperature, weather conditions motion data, and the like. This sensor data may be conveyed to data processing system 102 and SAP engine 104 for application to the virtual model(s). Once the virtual model is informed (e.g., annotated) with such data, the virtual model can be used to run simulations, study performance issues and generate possible improvements, with the goal of generating valuable insight that can be applied to the physical object that was modeled.

Packaging selector 210 is capable of selecting a packaging type for each package based on the results determined from the simulations performed by simulator 208. That is, based on the determined forces from the simulations for a given set of packages with a given stack configuration, packaging selector 210 is capable of selecting an appropriate container having a strength rating that indicates that the container is able to with withstand the forces determined from the simulation(s) without being damaged for each package. Further, packaging selector 210 is capable of selecting packing material(s), if any, to be included in the selected container for each package.

In one or more example implementations, the container type and/or packing material type may be selected based on the forces determined by way of simulation to be exerted on the packages throughout the route. That is, given two containers of similar or same attributes with respect to size and/or volume, packaging selector 210 may select one of the two containers having a higher strength rating for packages subjected to stronger forces (e.g., whether dynamic or static such as where the package is located in a lower layer of a stack) and the other of the two of a lesser strength rating for packages subjected to weaker forces (e.g., whether dynamic or static such as where the package is located in an upper layer of the stack). Still, the strength rating for the selected container for each package will meet or exceed the required strength rating for each package based on the determined forces from the simulation(s). Appreciably, the strength rating for each container for a package may be the lowest strength rating that meets or exceeds the forces to which the package is subjected per the specification of the container.

In another example, given two packing material types, packaging selector 210 may select one that increases the load bearing capacity of a container for packages subjected to stronger forces (e.g., whether dynamic or static such as where the package is located in a lower layer of a stack) and another that does not increase load bearing capacity or increases load bearing capacity by a lesser amount for packages subjected to weaker forces (e.g., whether dynamic or static such as where the package is located in an upper layer of the stack).

In one or more example implementations, the container type and/or packing material type may be selected based on the particular items included in the package. That is, given two containers of similar or same attributes with respect to ability to withstand forces, packaging selector 210 may select one of the two for food items and another for non-food items. Similarly, given two packing materials of similar or same attributes with respect to ability to withstand forces, packaging selector 210 may select one of the two for food items and another for non-food items. As an illustrative and non-limiting example, one type of container and/or packing material may have insulative properties that may be used for items that must be maintained at a particular temperature while the other(s) do not. In such cases, packaging selector 210 may choose those that are better suited to transport temperature sensitive items despite those containers and/or packing materials having a higher cost and same ability to withstand the dynamic forces expected to be applied to the package.

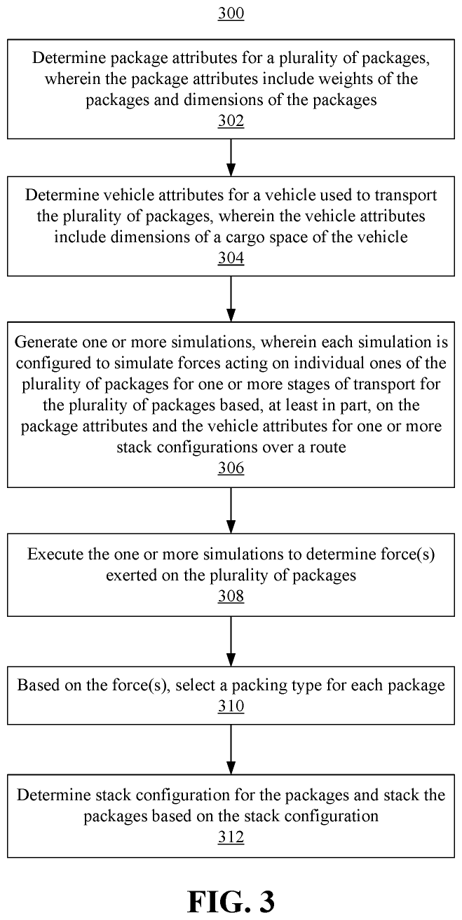

FIG. 3 is an example method 300 of operation of SAP engine 104 of FIGS. 1 and 2. Method 300 may be performed by SAP engine 104 executing within data processing system 102.

In block 302, SAP engine 104 is capable of determining package attributes for a plurality of packages. The package attributes can include weights of the packages and dimensions of the packages. In the example of FIG. 3, package generator 202 has allocated items of received orders to particular packages that are to be containerized and shipped. In one or more example implementations, each package, as generated by package generator 202, may be uniquely identifiable and also have a corresponding weight and dimensions that may be stored in package data 220.

In block 304, SAP engine 104 is capable of determining vehicle attributes for a vehicle used to transport the plurality of packages. The vehicle attributes can include dimensions of a cargo space of the vehicle. Thus, referring to blocks 302 and 304, collectively, SAP engine 104 is capable of identifying the vehicle dimensions and the package sizes. SAP engine 104 is capable of generating various alternative stack configurations for the packages given the package attributes and the vehicle attributes. For example, SAP engine 104 is capable of generating a plurality of different stack configurations using stack generator 204, where each stack configuration has a particular location assigned to each package of the stack and each stack configuration may differ with respect to the location of one or more packages therein.

In another example, SAP engine 104 is capable of determining, for each package, the particular route (e.g., route attributes) used to deliver the package and the particular delivery vehicle that is assigned to, or used on, the route. The route information may include a length of time that the package is to remain in particular stacks and can be further broken down into time that the packages are on delivery vehicles and the time that the packages are in warehouses. In block 306, SAP engine 104 is capable of generating one or more simulations. Each of the simulations is configured to simulate forces acting on individual ones of the plurality of packages for one or more segments of the route. The simulations are generated to simulate the effects of different combinations of the package attributes and the vehicle attributes for one or more of the stack configurations generated.

As noted, simulations may be generated for the different alternative stack configurations that may be generated in block 304. This allows each of the different stack configurations generated for a plurality of packages to be simulated throughout the route to the destination and/or for different segments of the route. As discussed, the route may include multiple segments in which the package travels in one or more different vehicles and/or is temporarily stored in one or more temporary holding facilities. During the different segments, a package may be grouped (e.g., stacked) with different packages and/or in different stack configurations. Thus, different simulations may be used to simulate dynamic and static forces on the packages for the different segments of a route.

For example, SAP engine 104 may determine end-to-end handing of packages. The end-to-end handling, as defined by and encapsulated by the route for each package, can include the segment of a route in which a transportation truck provides the package to a warehouse, a next segment in which the package is warehoused, and another segment in which a delivery vehicle carries the package from the warehouse to the destination (e.g., customer). During the first and/or second segments, the package may be stored on a shelf with minimal potential loading (e.g., in a first stack configuration). That is, packages on the shelf may have few layers such that the number of packages that may be stacked is limited. In the third segment of the route, the package may be included in a larger stack that may include more layers (e.g., a second and different stack configuration) thereby subjecting the package to increased load. Each portion of the route may be simulated. As discussed, the simulations may account for vibrations of the delivery vehicle as may be determined from the condition of the route, the type of delivery vehicle, the condition of the delivery vehicle including the suspension, and the like.

In accordance with the inventive arrangements described herein, SAP engine 104 is capable of simulating the stacking of the products with various transportation conditions discussed and based on times for the duration that the package remains in the stacks.

In one or more other examples, using a digital twin type of modeling, the simulation(s) may be performed historical sensor data collected for particular delivery vehicles and/or routes. In one or more other example implementations, using digital twin type of modeling, the simulation(s) may be performed using real-time sensor data obtained from other packages and/or delivery vehicles. This, actual conditions of the actual delivery vehicles and/or routes, whether historical or current (e.g., real-time) may be simulated to determine forces exerted on packages.

In block 308, SAP engine 104 is capable of executing the one or more simulations to determine one or more forces exerted on the plurality of packages. For example, simulator 208 is capable of executing the simulations generated by simulation generator 206. The simulations account for the package attributes and the vehicle attributes. The simulations may also take into account route attributes, historical shipping data and/or real-time shipping data. In simulating the various simulations, SAP engine 104 is capable of determining the different forces (e.g., static and/or dynamic) that the different packages are subjected to throughout the route. The forces determined may include the load placed on each package, e.g., the weight supported or born by each package. It should be appreciated that the forces exerted may include downward force (e.g., weight or load) but also include forces exerted on packages in various other directions. This may be performed for alternative stack configurations for the packages as well. The simulations apply the static and dynamic forces differently to the different layers of the various stack configurations throughout different portions of the route for the respective packages given the various other parameters described.

In one or more example implementations, the simulations, as executed, may use historical shipping data to determine how long packages are expected to remain in particular stack configurations during their respective routes. For example, if the package is stored in a warehouse, the simulations may simulate different storage times based on historical data in order to determine realistic forces exerted on the package for that portion of the route that accounts for time. If the package is transported by one or more different delivery vehicles over different segments of the route, the simulations may simulate different transit times for each of the different segments of the route using the appropriate route attributes, vehicle attributes, and length of time for each respective segment of the route to estimate forces applied to each package for the duration of the time period corresponding to each respective segment.

In block 310, the system is capable of selecting a packing type for each package based on the loads determined for each package for the entire route for the package(s). In one or more examples, SAP engine 104 determines the forces exerted on each package from the simulations for the entire route. Based on the determined forces (e.g., static and/or dynamic), packaging selector 210 selects a packaging type for the package. That is, the packaging selector 210 selects a particular container for the package and optionally selects packing material (if any) to be included in the container with the items of the package as containerized.

In one or more example implementations, based on the simulated results, packaging selector 210 is capable of selecting containers based on the forces applied to the respective packages to minimize the cost of packaging. That is, each package need only have a container with the lowest strength rating, per the container specification, that meets and/or exceeds the requirements given the forces exerted on the package to be included in the container as estimated from the simulations. The packaging selector 210 does not select a container that is stronger than necessary when a container of lesser strength meets the needs of a particular package in terms of withstanding the estimated forces exerted on the package for the route. In this manner, by selecting containers with strengths that meet or minimally exceed the required capabilities based on the forces determined from the simulations, packaging selector 210 is capable of minimizing the cost of packaging.

In block 312, SAP engine 104 optionally determines a stack configuration for the packages based, at least in part, on the simulation results and the selected packing type for the respective packages. For example, SAP engine 104 may select the particular stack configuration that was used as the basis for the packaging type selected in block 310. In one or more other embodiments, the stack configuration may be a predetermined stack configuration.

In one or more example implementations, SAP engine 104 is capable of communicating with a product packaging system and/or a product stacking system (e.g., robotic arm 106 or other mechanized and automated stacking machine) to instruct the respective machines how the containerize the packages and how to stack the packages once placed in containers.

In one aspect, SAP engine 104 optionally generates a stacking number for each package as containerized. The stacking number indicates the order in which the container is to be stacked to form the stack. Based on the order of the package, the container strength may be determined as the sequence number is correlated with the layer in which the package is placed to form the stack. Robotic arm 106 is capable of recognizing the stacking number to stack the packages, as containerized, in the correct order.

In one or more other example implementations, the stacking sequence can be conveyed from data processing system 102 to one or more peripheral devices such as Augmented Reality (AR) glasses that may be worn by users in cases where the containerized packages are to be manually placed in a stack. In that case, the stacking sequence (e.g., ordering of packages to form the stack) may be displayed in the AR glasses. The AR glasses may recognize identifiers placed on containers (e.g., bar codes, QR codes, or the like) to indicate which containers are to be selected next and visually illustrate the placement of the container within a stack configuration that is visualized to the user via the AR glasses.

As another illustrative and non-limiting example, SAP engine 104 may receive a plurality of packages to be delivered. A particular stack configuration may be specified for the plurality of packages. SAP engine 104 is capable of determining the product specifications for the various items in each package to determine the attributes of each package as described herein. Each package may be associated with a minimum packaging specification that defines a minimum packaging type to be used for each package. SAP engine 104 may generate simulations and execute the simulations to determine the load(s) to which each package is subjected for a given route. The simulation 104 may also account for historical damage to like packages for the route given like or same positions of the package in a stack configuration. SAP engine 104 is capable of modifying the packaging specification (e.g., selecting alternate or different) packaging type based on the simulation results. For example, SAP engine 104 may select different packaging type of a package in response to determining that the package was likely damaged during the simulation and/or determining that the maximum force(s) applied to the package during the simulation exceeded the capabilities of the minimum packaging specification associated with the package.

In one or more other embodiments, SAP engine 104 may be coupled to a communication system and provide notifications to a delivery vehicle and/or to a driver indicating adjustments to be made while in route. That is, for a given segment of the route, SAP engine 104 may notify the delivery vehicle and/or driver to drive with reduced speed since the segment of the route is known to result in damage to packages. In other cases, the messages from SAP engine 104 may be used to control certain vehicle parameters such as controlling the suspension of the delivery vehicle to soften or harden the suspension for different segments of the route based on the condition of the route and/or historical damage to packages for those segments of the route.

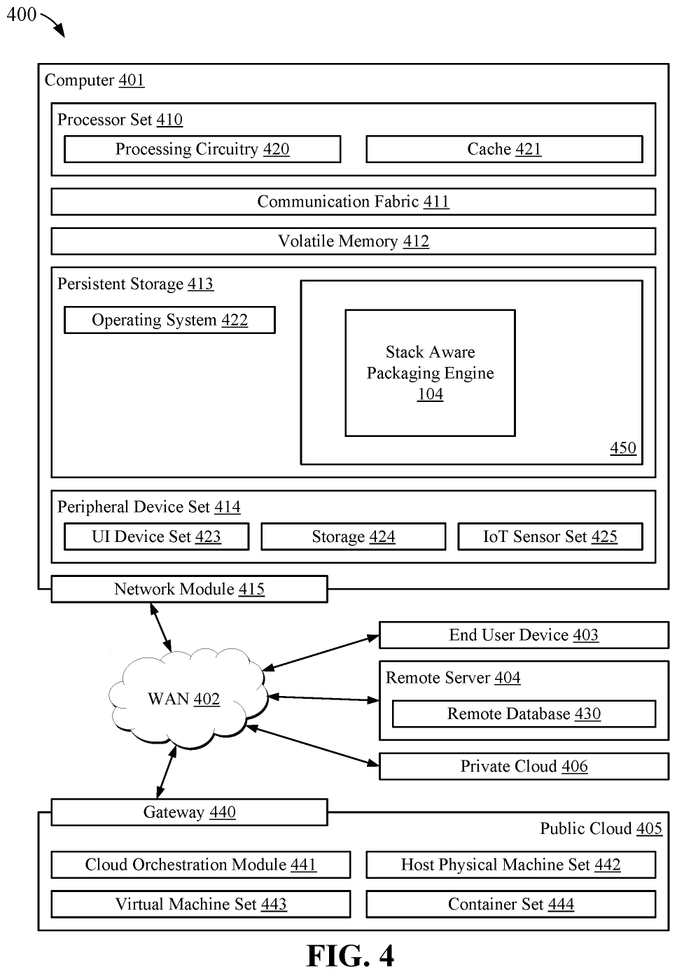

FIG. 4 illustrates an example implementation of a computing environment 400. Computing environment 400 contains an example of an environment for the execution of at least some of the computer code in block 450 involved in performing the inventive methods, such as SAP engine 104 implemented as executable program code or instructions. SAP engine 104 is capable of performing the various operations described herein. In addition to block 450, computing environment 400 includes, for example, computer 401 (e.g., data processing system 102), wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425 which may correspond to sensors 230), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors (e.g., hardware processors) of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

Communication fabric 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid-state storage devices. Operating system 422 may take several forms, such as various known proprietary operating systems or open-source Portable Operating System Interface type operating systems that employ a kernel. The code included in block 450 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (e.g., where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

The various types of data illustrated in FIG. 2 (e.g., 212-224) may be stored within storage 424, within remote database 430, or in any combination thereof.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (e.g., embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (e.g., a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that data items used, generated, and/or operated upon by data processing system 102 (e.g., computer 401) are functional data structures that impart functionality when employed by the data processing system. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a hardware processor.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or.” are open-ended expressions that are both conjunctive and disjunctive in operation unless explicitly stated otherwise. For example, each of the expressions “at least one of A, B and C.” “at least one of A, B, or C.” “one or more of A, B, and C.” “one or more of A, B, or C.” and “A, B, and/or C” means A alone, B alone, C alone, A and B together, A and C together, B and C together, or A, B and C together.

As defined herein, the term “automatically” means without user intervention.

As defined herein, the terms “includes,” “including.” “comprises,” and/or “comprising.” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real-time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
determining, using computer hardware, package attributes for a plurality of packages, wherein the package attributes include weights of the packages and dimensions of the packages;
determining, using the computer hardware, vehicle attributes for a delivery vehicle used to transport the plurality of packages, wherein the vehicle attributes include dimensions of a cargo space of the delivery vehicle;
generating, using the computer hardware, a simulation configured to simulate forces acting on individual ones of the plurality of packages as placed in a stack configuration for a route based on the package attributes and the vehicle attributes;
executing, using the computer hardware, the simulation to determine one or more forces exerted on respective ones of the plurality of packages; and
selecting, using the computer hardware, a packing type for each package based on the one or more forces exerted on the respective packages.

2. The method of claim 1, wherein the packing type includes a particular container for each package having a strength rating selected based on the one or more forces applied to the package.

3. The method of claim 1, wherein the packing type includes a particular packing material for each package.

4. The method of claim 1, wherein at least one of a height, a width, or a depth of the stack configuration is determined based on the dimensions of the cargo space of the vehicle.

5. The method of claim 1, wherein the vehicle attributes include a condition of the delivery vehicle.

6. The method of claim 1, wherein the simulation further determines the one or more forces exerted on the respective ones of the plurality of packages for the route based on route attributes.

7. The method of claim 1, wherein the simulation further determines the one or more forces exerted on the respective ones of the plurality of packages based on historical shipping data.

8. A system, comprising:
one or more processors configured to execute operations including:
determining package attributes for a plurality of packages, wherein the package attributes include weights of the packages and dimensions of the packages;
determining vehicle attributes for a delivery vehicle used to transport the plurality of packages, wherein the vehicle attributes include dimensions of a cargo space of the delivery vehicle;
generating a simulation configured to simulate forces acting on individual ones of the plurality of packages as placed in a stack configuration for a route based on the package attributes and the vehicle attributes;
executing the simulation to determine one or more forces exerted on respective ones of the plurality of packages; and
selecting a packing type for each package based on the one or more forces exerted on the respective packages.

9. The system of claim 8, wherein the packing type includes a particular container for each package having a strength rating selected based on the one or more forces applied to the package.

10. The system of claim 8, wherein the packing type includes a particular packing material for each package.

11. The system of claim 8, wherein at least one of a height, a width, or a depth of the stack configuration is determined based on the dimensions of the cargo space of the vehicle.

12. The system of claim 8, wherein the vehicle attributes include a condition of the delivery vehicle.

13. The system of claim 8, wherein the simulation further determines the one or more forces exerted on the respective ones of the plurality of packages for the route based on route attributes.

14. The system of claim 8, wherein the simulation further determines the one or more forces exerted on the respective ones of the plurality of packages based on historical shipping data.

15. A computer program product comprising one or more computer readable storage mediums having program instructions embodied therewith, wherein the program instructions are executable by one or more processors to cause the one or more processors to execute operations comprising:
determining package attributes for a plurality of packages, wherein the package attributes include weights of the packages and dimensions of the packages;
determining vehicle attributes for a delivery vehicle used to transport the plurality of packages, wherein the vehicle attributes include dimensions of a cargo space of the delivery vehicle;
generating a simulation configured to simulate forces acting on individual ones of the plurality of packages as placed in a stack configuration for a route based on the package attributes and the vehicle attributes;
executing the simulation to determine one or more forces exerted on respective ones of the plurality of packages; and
selecting a packing type for each package based on the one or more forces exerted on the respective packages.

16. The computer program product of claim 15, wherein the packing type includes a particular container for each package having a strength rating selected based on the one or more forces applied to the package.

17. The computer program product of claim 15, wherein the packing type includes a particular packing material for each package.

18. The computer program product of claim 15, wherein:
the vehicle attributes include a condition of the delivery vehicle; and
the route attributes include condition of the route.

19. The computer program product of claim 15, wherein the simulation further determines the one or more forces exerted on the respective ones of the plurality of packages for the route based on route attributes.

20. The computer program product of claim 15, wherein the simulation further determines the one or more forces exerted on the respective ones of the plurality of packages based on historical shipping data.
